(19) United States
(12) Patent Application Publication
(10) Pub. No.: US 2014/0313154 A1
(43) Pub. Date: Oct. 23, 2014

(54) BODY-COUPLED COMMUNICATION BASED ON USER DEVICE WITH TOUCH DISPLAY

(71) Applicants: Henrik Bengtsson, Lund (SE); Sarandis Kalogeropoulos, Malmo (SE); Daniel Lonnblad, Genarp (SE); Peter Karlsson, Lund (SE); Magnus Svensson, Malmo (SE)

(72) Inventors: Henrik Bengtsson, Lund (SE); Sarandis Kalogeropoulos, Malmo (SE); Daniel Lonnblad, Genarp (SE); Peter Karlsson, Lund (SE); Magnus Svensson, Malmo (SE)

(73) Assignee: SONY MOBILE COMMUNICATIONS AB, Lund (SE)

(21) Appl. No.: 13/823,319

(22) PCT Filed: Mar. 14, 2012
(86) PCT No.: PCT/IB2012/051211

§ 371 Date: Mar. 14, 2013

(51) Int. Cl. G06F 3/041; G06F 3/044

(52) U.S. Cl. CPC G06F 3/0416; G06F 3/044
USPC 345/174; 345/173

(57) ABSTRACT

A user device comprising a touch display; one or more memories to store instructions; and one or more processing systems to execute the instructions and cause the touch display to induce a body-coupled signal, in relation to a user of the user device, pertaining to a transmission of data.

### BACKGROUND

Body-coupled communication (BCC) is a communication in which the human body serves as a transmission medium. For example, a communication signal may travel on, proximate to, or in the human body. According to one known approach, this may be accomplished by creating a surface charge on the human body that causes an electric current and formation and re-orientation of electric dipoles of human tissue. A transmitter and a receiver are used to transmit a body-coupled signal and receive the body-coupled signal. There are a number of advantages related to body-coupled communication compared to other forms of communication, such as power usage, security, resource utilization, etc.

Currently, there are various drawbacks to this technology. For example, cost is a major consideration that prevents the commercialization of body-coupled communication. Additionally, the size and/or architecture of a system that provides body-coupled communication continue(s) to hinder its adoption as a viable form of communication.

### SUMMARY

According to one aspect, a user device may comprise a touch display; one or more memories to store instructions; and one or more processing systems to execute the instructions and cause the touch display to induce a body-coupled signal, in relation to a user of the user device, pertaining to a transmission of data.

Additionally, the user device may comprise a transmitter to transmit data to be carried by the induced body-coupled signal.

Additionally, the touch display may detect a body-coupled signal, in relation to the user of the user device, pertaining to a reception of data carried by the detected body-coupled signal.

Additionally, the touch display may comprise a projected capacitance touch architecture and the user device may comprise a receiver to receive data carried by the detected body-coupled signal.

Additionally, the touch display may use mutual capacitance.

Additionally, the user device may comprise a recognition component that recognizes at least one of a voice command or a gesture pertaining to a body-coupled communication, wherein the touch display may induce the body-coupled signal pertaining to the transmission of data based on the recognition component recognizing the at least one of the voice command of the user or the gesture of the user.

Additionally, the user device may comprise a mobile communication device and the touch display may be capable of at least one of touch operation or touchless operation.

According to another aspect, a method may comprise storing data by a user device; transmitting the stored data to a touch display of the user device; and inducing a body coupled signal, in relation to a user, via the touch display.

Additionally, the touch display may comprise a capacitive-based touch display, and the inducing may comprise transmitting a current to a driving circuit of the touch display, wherein the current is representative of the stored data.

Additionally, the method may comprise detecting a body-coupled signal based on the touch display; generating a signal based on the detected body-coupled signal; and restoring data carried by the detected body-coupled signal based on the signal.

Additionally, the detecting may comprise detecting capacitive changes via the touch display that are indicative of a body-coupled signal.

Additionally, the method may comprise transmitting the signal to a receiver of the user device, and decoding the signal.

Additionally, the touch display may comprise a projected capacitance touch architecture.

Additionally, the body-coupled signal may comprise payment information.

Additionally, the method may comprise recognizing at least one of a voice command or a gesture, and the transmitting may comprise transmitting the stored data to the touch display of the user device based on a recognition of the at least one of the voice command or the gesture, and inducing the body-coupled signal, in relation to the user, via the touch display.

### DESCRIPTION OF THE DRAWINGS

The accompanying drawings, which are incorporated in and constitute a part of this specification, illustrate exemplary embodiments described herein and, together with the description, explain these exemplary embodiments. In the drawings:

FIG. 1 is a diagram illustrating an exemplary environment in which body-coupled communication based on a user device with a touch display may be implemented;

FIG. 2 is a diagram illustrating an exemplary embodiment of a user device;

FIG. 3 is a diagram illustrating exemplary components of a user device;

FIGS. 4A and 4B are diagrams illustrating exemplary components of a touch display;

FIG. 5 is a flow diagram illustrating an exemplary process for transmitting a body-coupled signal via a touch display;

FIG. 6 is a flow diagram illustrating an exemplary process for receiving a body-coupled signal via a touch display; and

FIGS. 7-9 are diagrams illustrating exemplary scenarios pertaining to body-coupled communication via a user device with a touch display.

### DETAILED DESCRIPTION

The following detailed description refers to the accompanying drawings. The same reference numbers in different drawings may identify the same or similar elements.

User devices, such as mobile and handheld devices, include touch displays (also referred to as touch panels). Users may interact with the touch displays by touching their fingers or other instruments (e.g., a stylus, etc.) on the touch displays. Touch displays may include air-touch and air-gesture capabilities in which the users may interact with the touch displays without physically touching the touch displays.

According to an exemplary embodiment, a user device comprises a touch display that provides for the transmission and reception of body-coupled signals. According to an exemplary implementation, the touch display comprises a capacitive-based touch display. According to an exemplary embodiment, the user device comprises a transmitter capable of transmitting a signal via the touch display to induce a body-coupled signal. According to an exemplary embodiment, the user device comprises a receiver capable of receiving based on a body-coupled signal received by the touch display. The user may touch another device or another person to receive or transmit a body-coupled signal, as described further below.

According to an exemplary embodiment, the user device transmits the signal via the touch display in response to a voice command by the user. According to an exemplary implementation, the user device comprises a speech recognition component. According to an exemplary implementation, the user device comprises a voice recognition component. According to an exemplary embodiment, the user device transmits a signal via the touch display in response to a gesture performed by the user.

According to an exemplary embodiment, the touch display operates in different modes, such as a mode pertaining to touch operation or air-touch operation, and another mode pertaining to body-coupled communication.

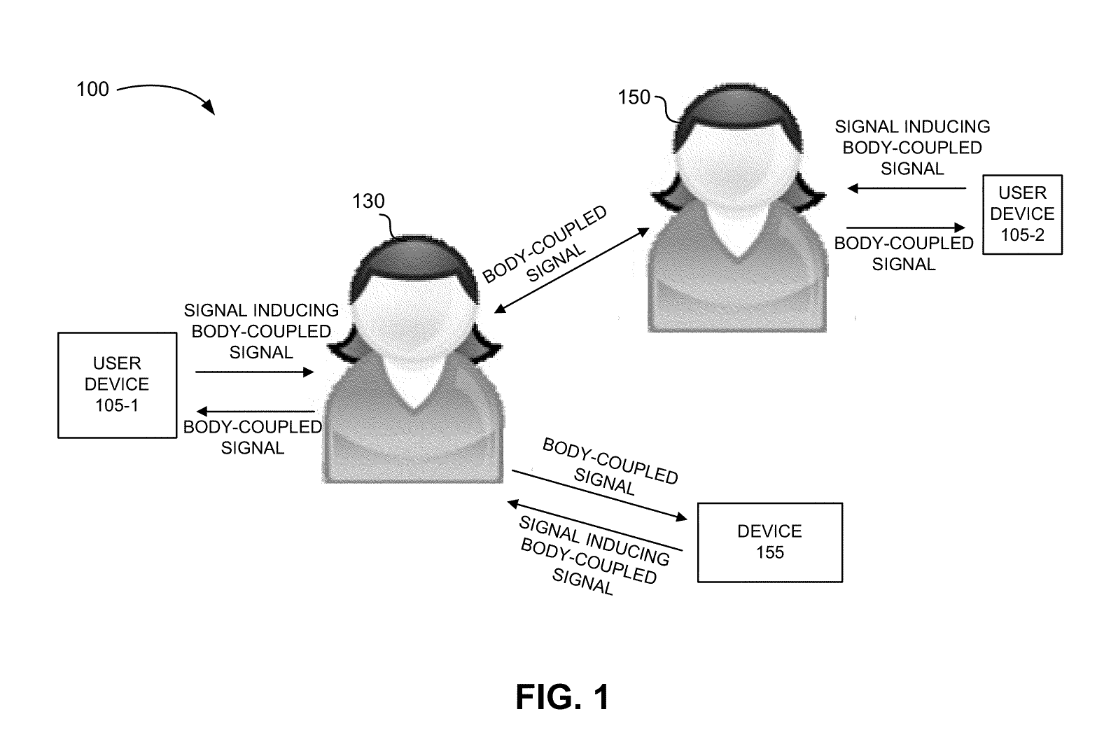

FIG. 1 is a diagram illustrating an exemplary environment in which body-coupled communication based on a user device with a touch display may be implemented. Environment 100 includes a user device 105-1 and a user 130, a user device 105-2 and a user 150, and a device 155. User devices 105-1 and 105-2 may also be referred to collectively as user devices 105 or individually as user device 105.

According to an exemplary embodiment, user device 105 comprises a portable device, a mobile device, a wrist-wear device, or a handheld device comprising a touch display having body-coupled communicative capabilities, as described herein. By way of example, user device 105 may be implemented as a smart phone, a wireless phone (e.g., a cellphone, a radio telephone, etc.), a personal digital assistant (PDA), a data organizer, a picture capturing device, a video capturing device, a Web-access device, a music playing device, a location-aware device, a gaming device, a computer, and/or some other type of user device.

Device 155 comprises a portable device, a mobile device, a handheld device, a wrist-wear device, or a stationary device capable of receiving a body-coupled signal and/or transmitting a signal inducing a body-coupled signal. By way of example, device 155 may be implemented as a monetary transactional device (e.g., an ATM device, a point of sale device, etc.), a kiosk device, a security device (e.g., a doorknob system, a device requiring authentication and/or authorization, etc.), or another type of device that has been implemented as a near-field communicative device. That is, devices that have relied on near-field communication to provide a function, a service, etc., such devices may be implemented to receive a body-coupled signal and/or transmit a signal inducing a body-coupled signal. In other words, body-coupled communication may serve as an alternative to near-field communication.

As illustrated in FIG. 1, user device 105-1 is capable of transmitting a signal that induces a body-coupled signal in relation to user 130 and is capable of receiving a body-coupled signal from user 130. Users 130 and 150 are capable of transmitting and receiving body-coupled signals relative to each other, and user 150 may communicate with user device 105-2 in a same manner as user 130 communicates with user device 105-1. As further illustrated, user 130 is capable of transmitting a body-coupled signal to device 155 and receiving a signal that induces a body-coupled signal from device 155. According to other embodiments, although not illustrated, user device 105 and/or device 155 may be communicatively coupled to another device, a network, etc.

With reference to environment 100 and according to an exemplary use case, user 130 may carry user device 105-1 in clothing (e.g., a pocket, etc.) or other manner (e.g., in a carrying case, wearing user device 105-1, etc.) that allows the touch display of user device 105-1 to be touching (e.g., entirely or a portion) user 130 or proximate to user 130. According to most use cases, the touch display of user device 105-1 will be touching user 130 in an indirect manner, such as, via clothing or a carrying case. However, in some use cases, user device 105 may be worn (e.g., a wrist-wear device).

As previously described, user device 105 comprises a touch display having body-coupled communicative capabilities. An exemplary embodiment of user device 105 is described further below.

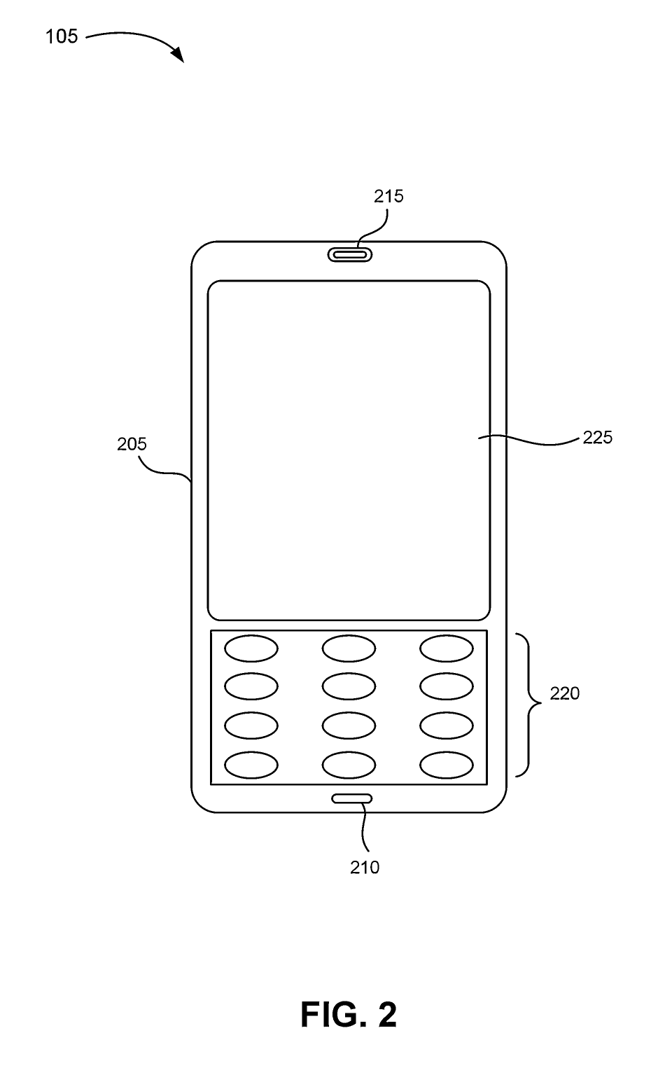

FIG. 2 is a diagram illustrating exemplary components of an exemplary embodiment of user device 105. As illustrated in FIG. 2, user device 105 may comprise a housing 205, a microphone 210, a speaker 215, keys 220, and a touch display 225. According to other embodiments, user device 105 may comprise fewer components, additional components, different components, and/or a different arrangement of components than those illustrated in FIG. 2 and described herein. Additionally, or alternatively, although user device 105 is depicted as having a portrait configuration, according to other embodiments, user device 105 may have a landscape configuration or some other type of configuration (e.g., a clamshell configuration, a slider configuration, a candy bar configuration, a swivel configuration, etc.).

Housing 205 comprises a structure to contain components of user device 105. For example, housing 205 may be formed from plastic, metal, or some other type of material. Housing 205 structurally supports microphone 210, speaker 215, keys 220, and touch display 225.

Microphone 210 comprises a microphone. For example, a user may speak into microphone 210 during a telephone call, speak into microphone 210 to execute a voice command, to execute a voice-to-text conversion, etc. Speaker 215 comprises a speaker. For example, a user may listen to music, to a calling party, etc., through speakers 215.

Keys 220 comprise keys, such as push-button keys or touch-sensitive keys. Keys 220 may comprise a standard telephone keypad, a QWERTY keypad, and/or some other type of keypad (e.g., a calculator keypad, a numerical keypad, etc.). Keys 220 may also comprise special purpose keys to provide a particular function (e.g., send a message, place a call, open an application, etc.) and/or allow a user to select and/or navigate through user interfaces or other content displayed by touch display 225.

Touch display 225 comprises a display having touch capabilities and/or touchless capabilities (e.g., air touch, air-gesture). According to an exemplary embodiment, touch display 225 may be implemented using capacitive sensing. According to other embodiments, touch display 225 may be implemented using capacitive sensing in combination with other sensing technologies, such as, for example, surface acoustic wave sensing, resistive sensing, optical sensing, pressure sensing, infrared sensing, gesture sensing, etc. Touch display 225 is described further below.

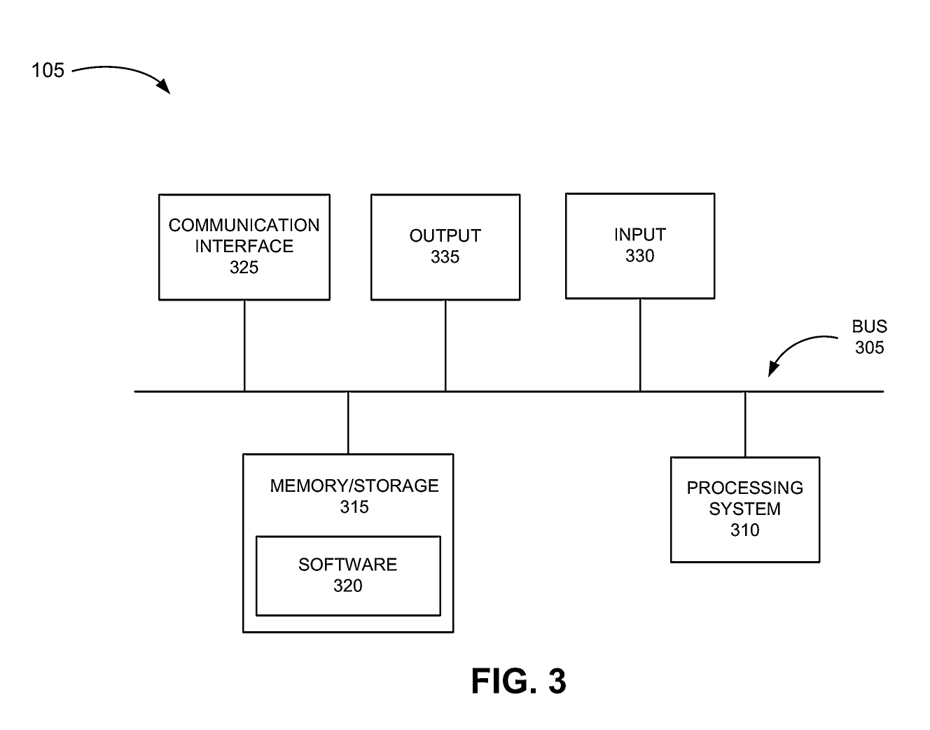

FIG. 3 is a diagram illustrating exemplary components of user device 105. As illustrated, user device 105 comprises a bus 305, a processing system 310, memory/storage 315 that comprises software 320, a communication interface 325, an input 330, and an output 335. According to other embodiments, user device 105 may comprise fewer components, additional components, different components, and/or a different arrangement of components than those illustrated in FIG. 3 and described herein.

Bus 305 comprises a path that permits communication among the components of user device 105. For example, bus 305 may comprise a system bus, an address bus, a data bus, and/or a control bus. Bus 305 may also include bus drivers, bus arbiters, bus interfaces, and/or clocks.

Processing system 310 comprises a processor, a microprocessor, a data processor, a co-processor, an application specific integrated circuit (ASIC), a system-on-chips (SOC), an application specific instruction-set processor (ASIP), a controller, a programmable logic device (PLD), a chipset, a field programmable gate array (FPGA), and/or some other processing logic that may interpret and/or execute instructions and/or data. Processing system 310 may control the overall operation, or a portion of operation(s) performed by user device 105. For example, processing system 310 may perform operations based on an operating system, various applications, and/or programs (e.g., software 320). Processing system 310 may access instructions from memory/storage 315, from other components of user device 105, and/or from a source external to user device 105 (e.g., another device or a network).

Memory/storage 315 comprises a memory and/or other type of storage medium. For example, memory/storage 315 may comprise one or multiple types of memories, such as, a random access memory (RAM), a dynamic random access memory (DRAM), a cache, a static random access memory (SRAM), a read only memory (ROM), a programmable read only memory (PROM), a ferroelectric random access memory (FRAM), an erasable programmable read only memory (EPROM), s static random access memory (SRAM), a flash memory, and/or some other form of hardware for storing. Memory/storage 315 may comprise a hard disk (e.g., a magnetic disk, an optical disk, a magneto-optic disk, a solid state disk, etc.) and a corresponding drive. Memory/storage 315 may be external to and/or removable from user device 105, such as, for example, a Universal Serial Bus (USB) memory, a dongle, etc. Memory/storage 315 may store data, software 320, and/or instructions related to the operation of user device 105.

Software 320 comprises software, such as, for example, an operating system and, application(s) and/or program(s). Software may comprise firmware. By way of example, software 320 may comprise a telephone application, a voice recognition application, a multi-media application, a texting application, an instant messaging application, etc. According to an exemplary embodiment, user device 105 includes software pertaining to body-coupled communication, as described herein.

Communication interface 325 comprises a wireless communication interface. For example, communication interface 325 comprises a transmitter and a receiver or a transceiver. Communication interface 325 may operate according to one or multiple protocols, communication standards, or the like. Communication interface 325 permits user device 105 to communicate with other devices, networks, and/or systems.

Input 330 permits an input into user device 105. For example, input 330 may comprise a keypad (e.g., keys 220), a display (e.g., touch display 225), a touch pad, a button, a switch, a microphone (e.g., microphone 210), an input port, a knob, and/or some other type of input component. Output 335 permits user device 105 to provide an output. For example, output 335 may include a display (e.g., touch display 225), a speaker (e.g., speakers 215), a light emitting diode (LED), an output port, a vibratory mechanism, or some other type of output component.

User device 105 may perform operations or processes in response to processing system 310 executing instructions (e.g., software 320) stored by memory/storage 315. For example, the instructions may be read into memory/storage 315 from another storage medium or from another device via communication interface 325. The instructions stored by memory/storage 315 may cause processing system 310 to perform various operations or processes. Alternatively, user device 105 may perform processes based on the execution of hardware.

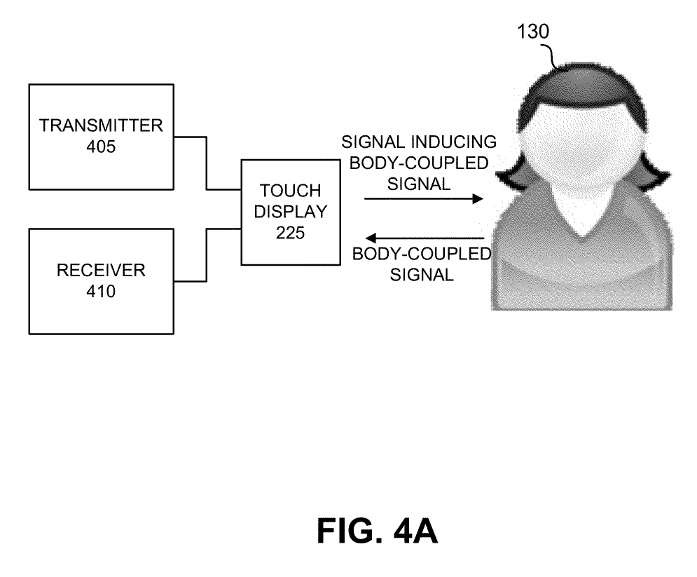

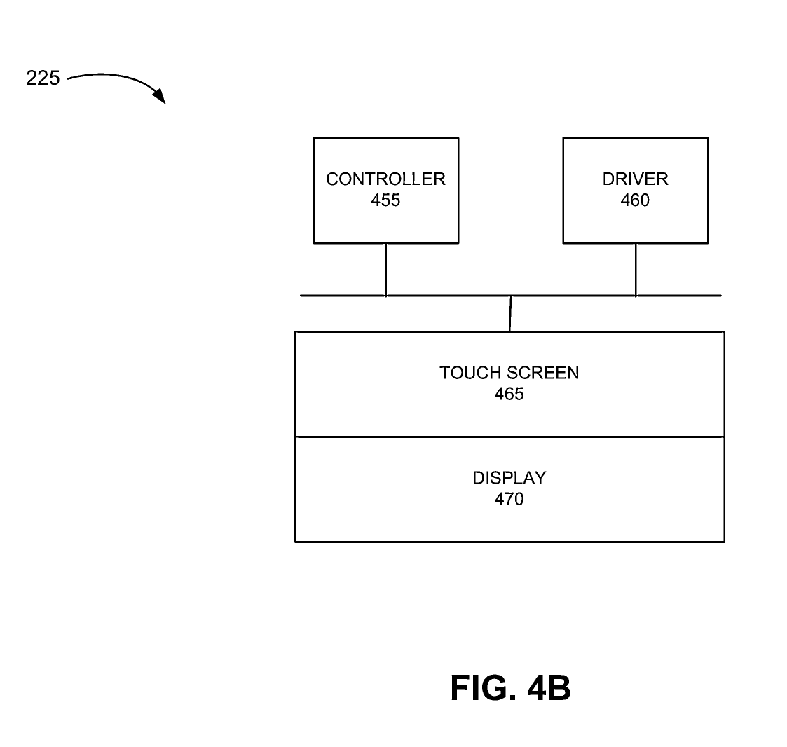

FIG. 4A is a diagram illustrating exemplary components of an exemplary embodiment of user device 105. For example, user device 105 includes a transmitter 405 and a receiver 410. Transmitter 405 and receiver 410 may be a dedicated component to body-coupled communication and/or incorporated into an existing architecture (e.g., communication interface 325, controller logic for touch screen, etc.).

According to an exemplary implementation, as previously described, touch display 225 comprises a capacitive-based display having touch capabilities and/or touchless capabilities (e.g., air touch, air-gesture). By way of further example, touch display 225 comprises a Projected Capacitive Touch (PCT) architecture. There are a wide range of touch-sensor layer structures. However, the PCT architecture comprises an insulator (e.g., a glass layer, a plastic layer, a foil layer, or the like) and a conductor (e.g., one or multiple conductive, transparent layers, such as an indium tin oxide (ITO) layer, a copper layer, a nanocarbon layer, an antimony-doped tin oxide (ATO) layer, a zinc oxide layer, an aluminum-doped zinc oxide layer, or the like). A grid (e.g., an X-Y grid or other type of coordinate grid) may be formed with respect to, for example, the conductor and provide a pattern (e.g., diamonds, triangles, snowflakes, streets and alleys, etc.) of electrodes. The PCT architecture may be implemented as self capacitance or mutual capacitance. According to another implementation, touch display 225 comprises a surface capacitive touch architecture.

As illustrated in FIG. 4B, touch display 225 also comprises a controller 455 and a driver 460. For description purposes, a touch screen 465 (e.g., having a PCT architecture) and a display 470 is also illustrated. The connections between these components are merely exemplary. According to an exemplary implementation, controller 455 and/or driver 460 correspond to a controller and/or a driver dedicated to body-coupled communication. According to another exemplary implementation, controller 455 and/or driver 460 may operate in a body-coupled communication mode and, a touch and/or air-touch, air-gesture mode.

Controller 455 comprises logic to control, for example, panel driving and sensing circuits, power circuits, and digital signal processing pertaining to touch screen 465. Driver 460 comprises software that manages the operation of touch screen 465, such as, for example, enabling and disabling, power-state change notifications, and calibration functions pertaining to touch screen 465. According to an exemplary implementation, driver 460 may set mode information for touch screen 465, which includes a body-coupled communication mode and a touch and/or air-touch/gesture mode.

Referring to FIGS. 4A and 4B, an exemplary process pertaining to transmission of data via touch display 225 to induce a body-coupled signal is described. For example, a data source (not illustrated) provides transmitter 405 with data to transmit and transmitter 405 transmits a signal to controller 455. In response, controller 455 controls the panel driving circuits and the grid to induce a body-coupled signal. For example, an alternating current representative of the data drives the grid (e.g., the X-Y grid) or a portion of the grid (e.g., all rows, all columns, a section of the grid underlying a portion of touch screen 465 determined to be touching a user or closest in proximity to a user, etc.) to induce the body-coupled signal.

Referring to FIGS. 4A and 4B, an exemplary process pertaining to reception of data via touch display 225 in which touch display 225 receives a body-coupled signal is described. For example, a body-coupled signal propagates via user 130 in which touch display 225 is touching or in close proximity to user 130. The body-coupled signal affects a capacitance relative to the grid or a portion of the grid. The sensing circuits detect the capacitive changes caused by the body-coupled signal and controller 455 measures the capacitive changes. By way of example, the sensing circuits and/or controller 455 may use capacitive signatures, which are stored by user device 105, to identify capacitive changes indicative of a body-coupled signal. Controller 455 generates a signal in correspondence to the measured capacitive changes and provides the signal to receiver 410. Receiver 410 recovers data based on the signal.

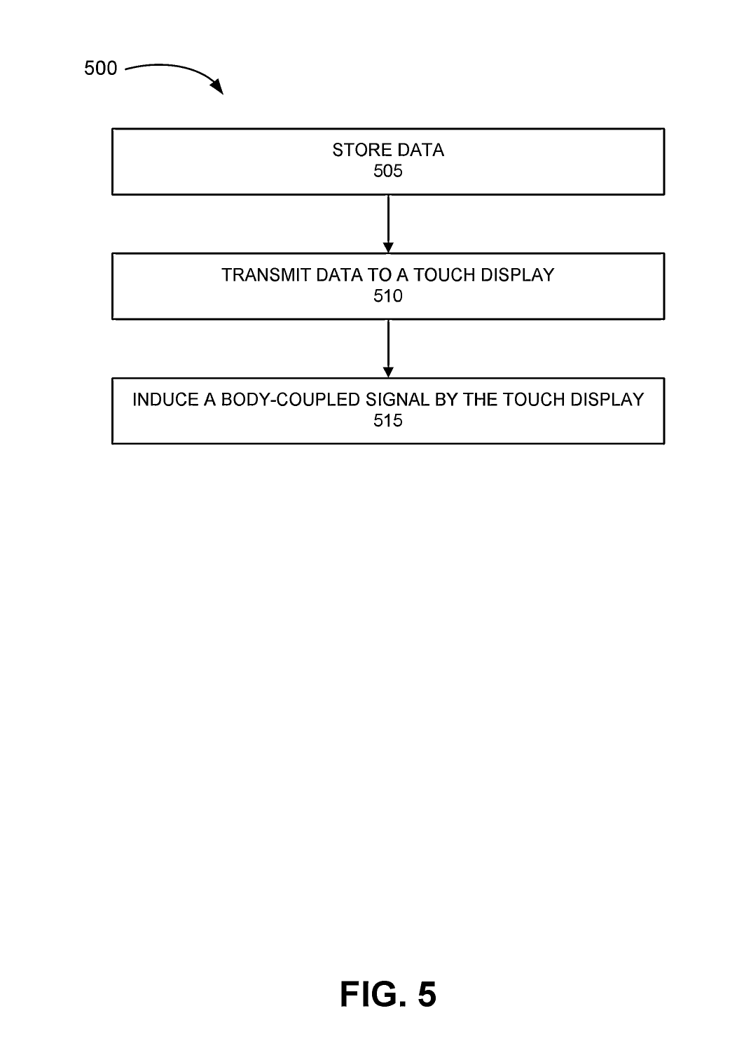

FIG. 5 is a flow diagram illustrating an exemplary process 500 for transmitting a body-coupled signal via a touch display. Process 500 is performed by various components of user device 105, as described herein.

Process 500 begins with storing data (block 505). For example, data or information is stored by user device 105 for transmitting as a body-coupled communication. For example, the data or information may be related to software 320 (e.g., an application) or other type of file (e.g., a contact entry, a business card, etc.).

In block 510, data is transmitted to a touch display. For example, transmitter 405 transmits the data to touch display 225. As previously described, the data may be transmitted in response to a voice command or a gesture. According to other examples, the data may be transmitted based on the geographic location of the user, the date and time of the user, or other user-configurable parameters (e.g., use-case history, etc.). Transmitter 405 may perform encoding, error control, and/or other types of signal processing to prepare the signal for transmission.

In block 515, a body-coupled signal is induced by the touch display. For example, touch display 225 induces a body-coupled signal in correspondence to the data or information. According to an exemplary implementation, as previously described, controller 455 controls the panel driving circuits and the grid of touch display 225. For example, an alternating current representative of the data or information drives the grid, or a portion of the grid of touch display 225 to induce the body-coupled signal.

Although FIG. 5 illustrates an exemplary process 500, according to other embodiments, process 500 may include additional operations, fewer operations, and/or different operations than those illustrated in FIG. 5 and described.

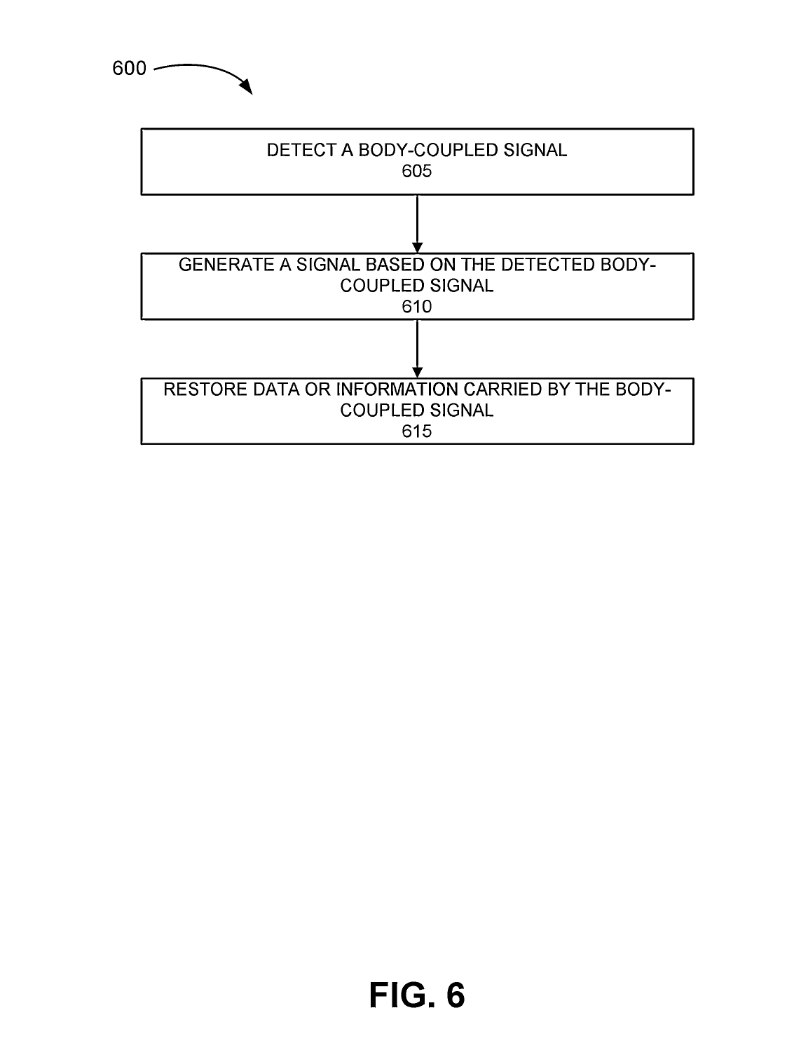

FIG. 6 is a flow diagram illustrating an exemplary process 600 for receiving a body-coupled signal via a touch display. Process 600 is performed by various components of user device 105, as described herein.

Process 600 begins with detecting a body-coupled signal (block 605). For example, sensing circuits of touch display 225 detect capacitive changes caused by a body-coupled. Controller 455 measures the capacitive changes and identifies that a body-coupled communication is being received. By way of example, the sensing circuits and/or controller 455 may use capacitive signatures, which are stored by user device 105, to identify capacitive changes indicative of a body-coupled signal.

In block 610, a signal based on the detected body-coupled signal is generated. For example, controller 455 generates a signal in correspondence to the measured capacitive changes and provides the signal to receiver 410.

In block 615, data or information carried by the body-coupled signal is restored. For example, receiver 410 recovers the data or information based on the signal. For example, receiver 410 may perform decoding, error detection and correction, and/or other types of signal processing to restore the data or information.

Although FIG. 6 illustrates an exemplary process 600, according to other embodiments, process 600 may include additional operations, fewer operations, and/or different operations than those illustrated in FIG. 6 and described.

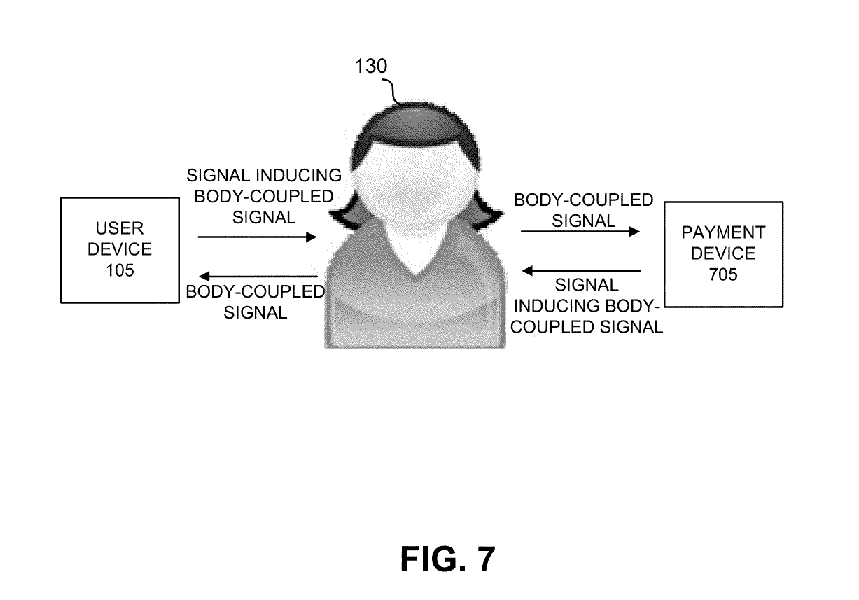

FIGS. 7, 8, and 9 are diagrams illustrating exemplary scenarios pertaining to body-coupled communication based on touch display 225 of user device 105.

Referring to FIG. 7, assume that user 130 is located in a store to purchase an item. In contrast to existing methods in which a user removes a credit card or money from his wallet or her purse to purchase the item, or a user removes user device 105 from his or her pocket for near-field communication to purchase the item, in this case, user 130 leaves user device 105 in his or her pocket or carrying case. User 130 touches payment device 705 with his or her hand and a body-coupled communication (e.g., a secure payment transaction) takes place between user device 105 via touch display 225, user 130, and payment device 705. Payment device 705 includes a component for body-coupled communication.

According to an exemplary embodiment, user device 105 comprises payment software that manages the payment transaction. For example, the payment software may provide authentication, authorization, certification, and/or a pin-code on behalf of user 130 depending on the payment transaction characteristics of payment device 705 and/or the payment software of user device 105. Other forms of security measures may be implemented, such as fingerprint recognition, voice detection, or other types of biometric analytics.

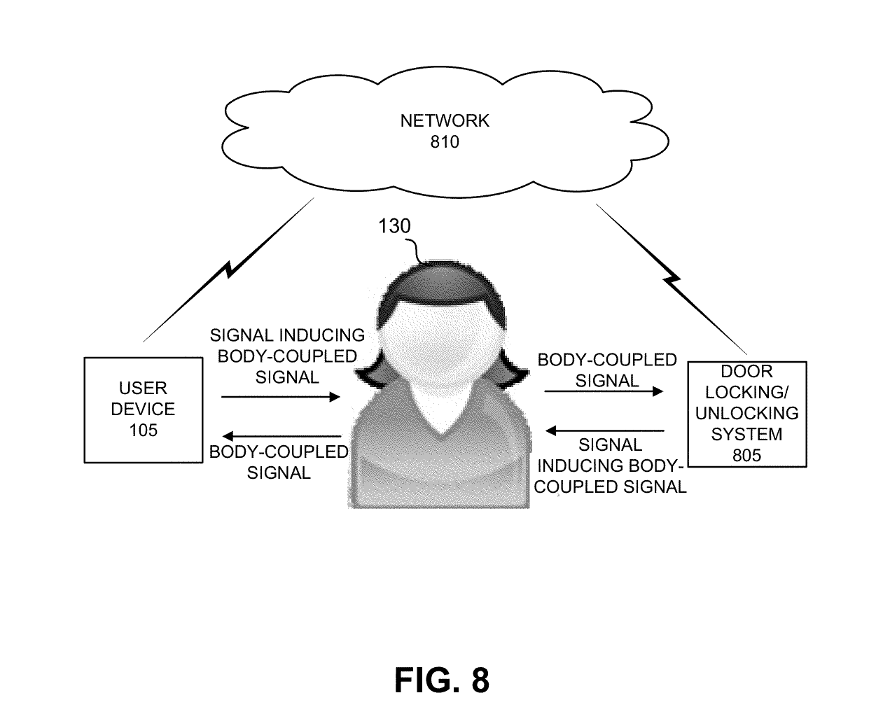

Referring to FIG. 8, assume that user 130 is located at work and needs to unlock a door. The door includes a door locking/unlocking system 805. In contrast to existing methods in which a user removes a security card, in this case, user 130 leaves user device 105 in his or her pocket or carrying case. User 130 touches door locking/unlocking system 805. Door locking/unlocking system 805 sends information (e.g., a web address or other type of network address) to user device 105 via a body-coupled communication. In response to receiving the information, user device 105 connects to door locking/unlocking system 805 via network 810 based on the information. According to an exemplary implementation, security information may be transmitted and/or received between user device 105 and door locking/unlocking system 805 via network 810 using a secure link (e.g., a Secure Sockets Layer (SSL) link, an encrypted link, etc.). Network 810 may comprise, for example, a cellular network, the Internet, a private network, and/or other suitable network.

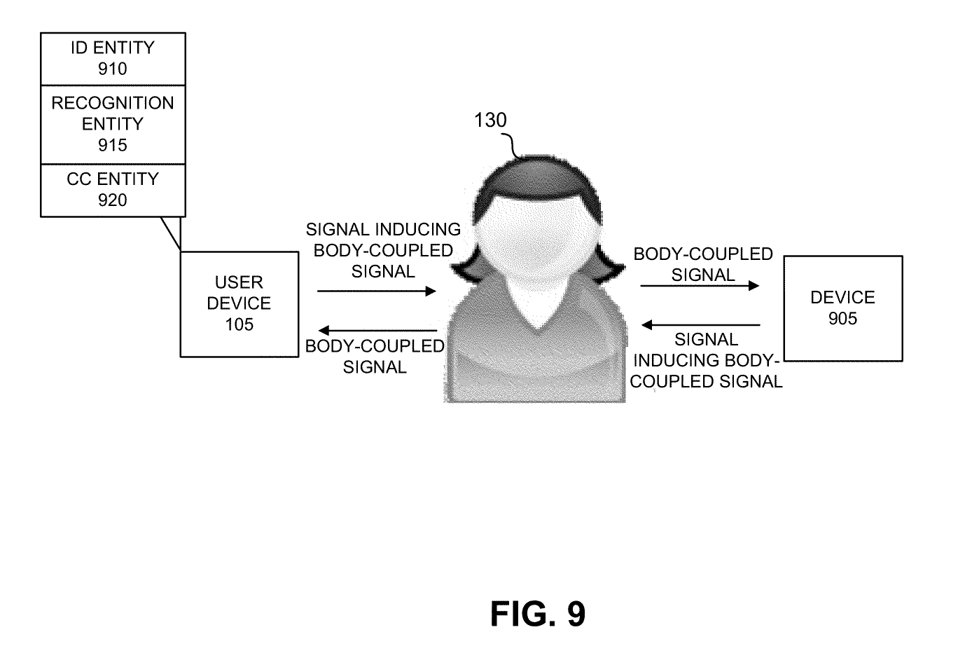

Referring to FIG. 9, assume that user 130 wishes to interact with device 905 using body-coupled communication via user device 105. According to an exemplary embodiment, user 105 includes an identification (ID) entity 910, a recognition entity 915, and a capacitive communication (CC) entity 920.

Identification entity 910 manages information about the user (e.g., user 130) and/or user device 105. For example, the information may include subscriber identity module (SIM) card information. Recognition entity 915 recognizes voice commands and/or user gestures. For example, a user's voice command or a user's gesticulation may initiate a type of body-coupled communication (e.g., a payment transaction, an unlocking of a door, etc.). According to other implementations, recognition entity 910 may recognize other types of information, such as time, place, body-coupled communication user history, etc., pertaining to user 130. Capacitive communication entity 920 manages the transmission and reception of information via a body-coupled channel. For example, capacitive communication entity 920 identifies and selects appropriate information to transmit via a body-coupled channel.

According to an exemplary scenario, assume that user 130 vocalizes a voice command (e.g., pay 20 dollars). Recognition entity 915 detects the voice command and sends this information to capacitive communication entity 920. Capacitive communication entity 920 obtains identification information from identification entity 910. Capacitive communication entity 920 combines the identification information and the voice command information and transfers this information to device 905 (e.g., a payment device) via touch display 225 of user device 105. A payment of 20 dollars is made device 905.

According to another implementation, user 130 may perform a gesture (e.g., waving a hand or other form of gesticulation) as a sign to pay. The gesture may be detected by device 905 (e.g., via a camera) and gesture information may be sent to user device 105 (e.g., via a body-coupled communication). Recognition entity 915 recognizes the gesture information and capacitive communication entity 920 completes the payment transaction, as previously described. According to another implementation, user 130 may perform a gesture and user device 105 (e.g., via a camera) detects the gesture. Recognition entity 915 recognizes the gesture and capacitive communication entity 920 completes the payment transaction, as previously described. In this way, a user (e.g., user 130) may indicate a type of action or a type of body-coupled communication (e.g., a payment transaction, to exchange a business card, to unlock or lock a door, etc.) based on a voice command and/or a gesture. The scenarios described for FIGS. 7-9 are merely exemplary, and other types of body-coupled communications and/or transactions may be performed relative to other users, user devices, devices, etc., not specifically described herein.

The foregoing description of embodiments provides illustration, but is not intended to be exhaustive or to limit implementations to the precise form disclosed. Modifications and variations of the embodiments and/or implementations are possible in light of the above teachings, or may be acquired from practice of the teachings.

The flowcharts and blocks illustrated and described with respect to FIGS. 5 and 6 illustrate exemplary processes according to an exemplary embodiment. However, according to other embodiments, the function(s) or act(s) described with respect to a block or blocks may be performed in an order that is different than the order illustrated and described. For example, two or more blocks may be performed concurrently, substantially concurrently, or in reverse order, depending on, among other things, dependency of a block to another block.

The terms “comprise,” “comprises” or “comprising,” as well as synonyms thereof (e.g., include, etc.), when used in the specification is meant to specify the presence of stated features, integers, steps, or components but does not preclude the presence or addition of one or more other features, integers, steps, components, or groups thereof. In other words, these terms are to be interpreted as inclusion without limitation.

The term “logic” or “component,” when used in the specification may include hardware (e.g., processing system 310), a combination of hardware and software (software 320), a combination of hardware, software, and firmware, or a combination of hardware and firmware. The terms “a,” “an,” and “the” are intended to be interpreted to include both the singular and plural forms, unless the context clearly indicates otherwise. Further, the phrase “based on” is intended to be interpreted to mean, for example, “based, at least in part, on,” unless explicitly stated otherwise. The term “and/or” is intended to be interpreted to include any and all combinations of one or more of the associated list items.

In the specification and illustrated by the drawings, reference is made to “an exemplary embodiment,” “an embodiment,” “embodiments,” etc., which may include a particular feature, structure or characteristic in connection with an embodiment(s). However, the use of these terms or phrases does not necessarily refer to all embodiments described, nor does it necessarily refer to the same embodiment, nor are separate or alternative embodiments necessarily mutually exclusive of other embodiment(s). The same applies to the term “implementation,” “implementations,” etc.

No element, act, or instruction disclosed in the specification should be construed as critical or essential to the embodiments described herein unless explicitly described as such.

What is claimed is:

1. A user device comprising:
a touch display;
one or more memories to store instructions; and
one or more processing systems to execute the instructions and cause the touch display to:
induce a body-coupled signal, in relation to a user of the user device, pertaining to a transmission of data.

2. The user device of claim 1, further comprising:
a transmitter to transmit data to be carried by the induced body-coupled signal.

3. The user device of claim 1, wherein the one or more processing systems further execute the instructions and cause the touch display to:
detect a body-coupled signal, in relation to the user of the user device, pertaining to a reception of data carried by the detected body-coupled signal.

4. The user device of claim 3, wherein the touch display comprises a projected capacitance touch architecture, and the user device further comprising:
a receiver to receive data carried by the detected body-coupled signal.

5. The user device of claim 4, wherein the touch display uses mutual capacitance.

6. The user device of claim 1, further comprising:
a recognition component that recognizes at least one of a voice command or a gesture pertaining to a body-coupled communication, wherein the one or more processing systems further execute the instructions and cause the touch display to:
induce the body-coupled signal pertaining to the transmission of data based on the recognition component recognizing the at least one of the voice command of the user or the gesture of the user.

7. The user device of claim 1, wherein the user device comprises a mobile communication device and the touch display is capable of at least one of touch operation or touchless operation.

8. A method comprising:
storing data by a user device;
transmitting the stored data to a touch display of the user device; and
inducing a body-coupled signal, in relation to a user, via the touch display.

9. The method of claim 8, wherein the touch display comprises a capacitive-based touch display, and the inducing comprises:
transmitting a current to a driving circuit of the touch display, wherein the current is representative of the stored data.

10. The method of claim 8, further comprising:
detecting a body-coupled signal based on the touch display;
generating a signal based on the detected body-coupled signal; and
restoring data carried by the detected body-coupled signal based on the signal.

11. The method of claim 10, wherein the detecting comprises:
detecting capacitive changes via the touch display that are indicative of a body-coupled signal.

12. The method of claim 10, further comprising:
transmitting the signal to a receiver of the user device; and
decoding the signal.

13. The method of claim 8, wherein the touch display comprises a projected capacitance touch architecture.

14. The method of claim 8, wherein the body-coupled signal comprises payment information.

15. The method of claim 8, further comprising:
recognizing at least one of a voice command or a gesture, and wherein the transmitting comprises:
transmitting the stored data to the touch display of the user device based on a recognition of the at least one of the voice command or the gesture; and
inducing the body-coupled signal, in relation to the user, via the touch display.
